(19) United States
(12) Patent Application Publication
(10) Pub. No.: US 2014/0093106 A1
(43) Pub. Date: Apr. 3, 2014

(54) Diaphragm

(71) Applicant: Tao Shen, Shenzhen (CN)

(72) Inventor: Tao Shen, Shenzhen (CN)

(73) Assignees: AAC MICROTECH (CHANGZHOU) CO., LTD., Changzhou (CH); AAC ACOUSTIC TECHNOLOGIES (SHENZHEN) CO., LTD., Shenzhen (CN)

(21) Appl. No.: 14/036,340

(22) Filed: Sep. 25, 2013

(30) Foreign Application Priority Data
Sep. 28, 2012 (CN) 201220503817.7

(51) Int. Cl. H04R 7/00

(52) U.S. Cl. CPC H04R 7/00
USPC 381/162

(57) ABSTRACT

A diaphragm includes a central portion and an edge portion surrounding the central portion and smoothly connecting with the central portion. The edge portion has a main curved portion which is convex forward in the vibrating direction and a first side curved portion continued to an inner periphery of the main curved portion and connected with the central portion. The first side curved portion is convex backward in the vibrating direction. The rigidity of the diaphragm can be increased, without sacrificing the acoustic characteristics and reducing the size of the diaphragm.

### FIELD OF THE INVENTION

The present invention generally relates to the art of diaphragms and, more particularly, to a diaphragm of a speaker.

### DESCRIPTION OF RELATED ART

An electronic device, such as a cellular phone, a camcorder, a PDA, a digital camera, or a notebook computer, provides a space for accommodating a speaker therein. Nowadays, a speaker with high quality audio performance and miniature size is desired. The diaphragm is very important to the speaker.

A related diaphragm comprises a dome part and an edge part connecting with the dome part and extending upwardly from the dome part, directly. A height difference from an apex of the edge part to a joint position of the edge part and the dome part is defined as a rising height of the edge part. To increase the rising height of the edge part can increase the rigidity and the sensitivity of the diaphragm. But, increasing the rigidity and the sensitivity of the diaphragm by increase the height difference makes it difficult to miniaturize the speaker.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a diaphragm.

FIG. 2 is a cross-sectional view illustrating the diaphragm taken along line A-A of FIG. 1.

FIG. 3 is an enlarged view of Part B in FIG. 2.

### DETAILED DESCRIPTION OF THE EXEMPLARY EMBODIMENT

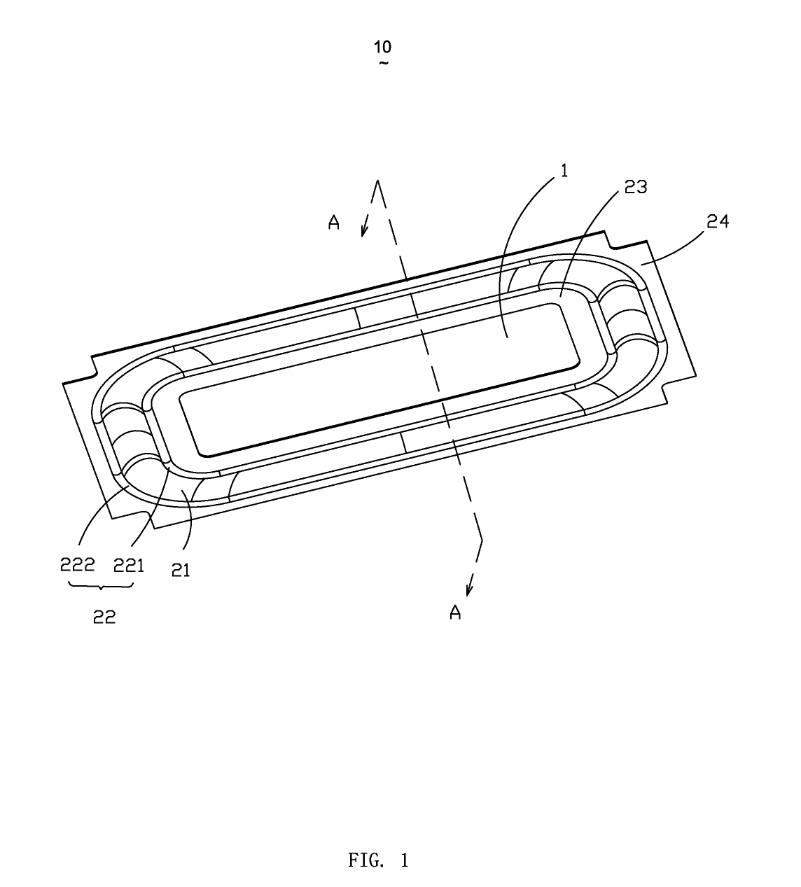

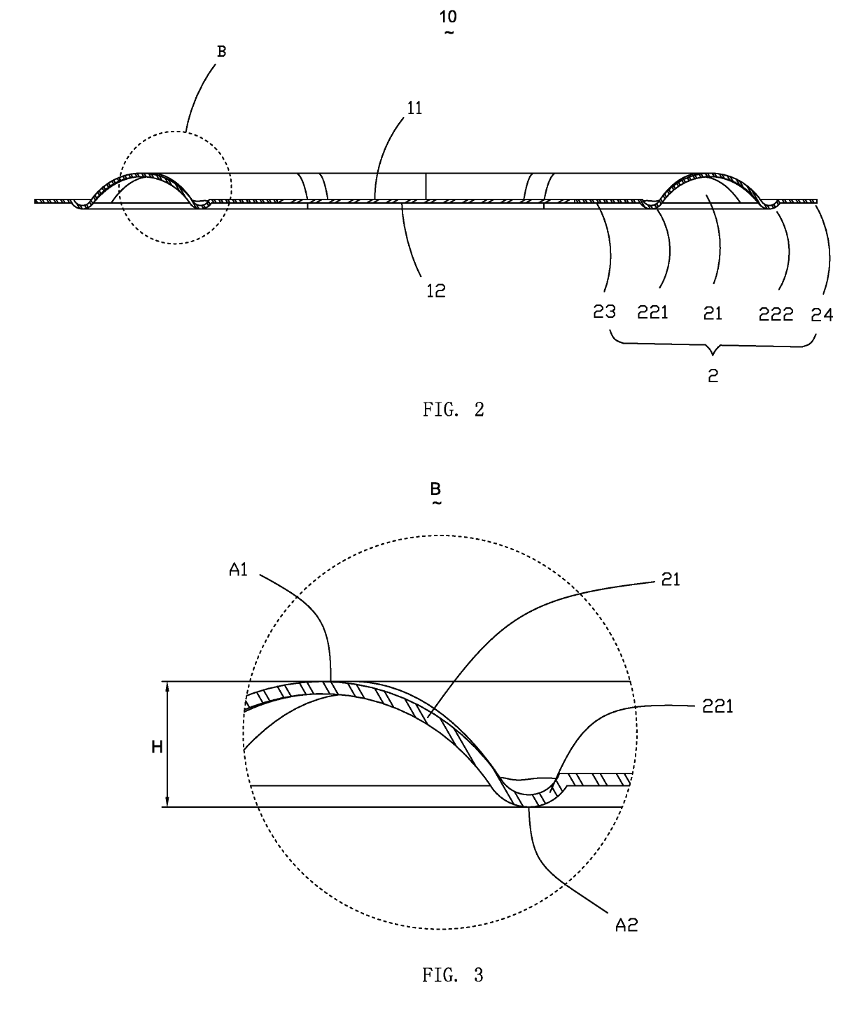

Referring to FIGS. 1 through 3, a diaphragm 10, according to an exemplary embodiment, includes a central portion 1 in a center thereof and an edge portion 2 surrounding the central portion and smoothly connecting with the central portion 1. The diaphragm 10 is capable of being vibrated along a vibrating direction. The central portion 1 has a first surface 11 and a second surface 12 opposite to the first surface 11.

The edge portion 2 has a main curved portion 21 which is convex forward in the vibrating direction to form an annular bulge and a side curved portion 22 which is provided in continuation to the main curved portion 21 and is convex backward in the vibrating direction. The side curved portion 22 has a first side curved portion 221 continued to an inner periphery of the main curved portion 21 and a second side curved portion 222 continued to an outer periphery of the main curved portion 21. The edge portion 2 further has a connecting portion 23 connected with the central portion 1 and the first side curved portion 221 and a fixing portion 24 disposed at an outer periphery of the second side curved portion 222. The central portion can be, but is not limited to a planar. The connecting portion 23 is integral with or attached on the central portion 1. A height difference from a bottom of the first side curved portion to an apex A1 of the main curved portion is defined as a rising height h of the main curved portion 21.

The side curved portion 22 has a curved face which has a smaller radius of curvature than a curved face of the main curved portion 21. The side curved portion 22 has a curved shape which is convex backward in the vibrating direction, contrarily to the main curved portion 21 of the edge portion 2, and functions to retract its joint position with the main curved portion 21 backward in the vibrating direction. For this reason, a rising height H of the main curved portion 21 can be sufficiently secured without changing a position of the apex A1 of the main curved portion 21 of the edge portion 2, and in this manner, enhancement of the rigidity of the edge portion 2 due to an increase in the rising height H of the main curved portion 21 can be attained.

In other words, the rising height H of the main curved portion 21 can be increased without changing a vertical position of the apex A1 of the main curved portion 21. Therefore, the rigidity of the edge portion can be increased, without sacrificing the acoustic characteristics and reducing the size of the diaphragm. Further, the position of the apex A1 of the main curved portion can be shifted radially outwardly because of presence of the first side curved portion, and a distance in a horizontal direction between the apexes A1 and a center of the central portion can be increased. This contributes in preventing the interference of sounds with the main curved portion and the central portion.

The first side curved portion and the second side curved portion are symmetrical with respect to the main curved portion, thereby balancing the vibrating of the diaphragm. The second side curved portion further has the advantage of capability of effectively decreasing distortion and increasing the rigidity of the edge portion.

It is to be understood, however, that even though numerous characteristics and advantages of the present embodiment have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A diaphragm capable of being activated to vibrate along a vibrating direction, comprising:
a central portion; and
an edge portion surrounding the central portion and smoothly connecting with the central portion;
wherein, the edge portion has a main curved portion which is convex forward in the vibrating direction and a first side curved portion continued to an inner periphery of the main curved portion and connected with the central portion and
wherein, the first side curved portion is convex backward in the vibrating direction.

2. The diaphragm as claimed in claim 1 further comprises a second side curved portion continued to an outer periphery of the main curved portion.

3. The diaphragm as claimed in claim 1 further comprises a connecting portion connected with the central portion and the first side curved portion.

4. The diaphragm as claimed in claim 3, wherein the first side curved portion and the second side curved portion are symmetrical with respect to the main curved portion.

5. The diaphragm as claimed in claim 2 further comprises a fixing portion disposed at an outer periphery of the second side curved portion.
